(19) United States
(12) Patent Application Publication
(10) Pub. No.: US 2004/0078316 A1
(43) Pub. Date: Apr. 22, 2004

(54) Network directory for business process integration of trading partners

(75) Inventors: Gregory Scott Clark, Hillsborough, CA (US); Andre Srinivasan, San Francisco, CA (US); David Burgess, Palo Alto, CA (US); David Schneider, Austin, TX (US); Gilbert Pilz, Santa Cruz, CA (US); Karthik Srinivasan, Sunnyvale, CA (US)

Correspondence Address: SWERNOFSKY LAW GROUP PC, P.O. BOX 390013, MOUNTAIN VIEW, CA, 94039-0013, US

(73) Assignee: E2open LLC, a corporation, Redwood City, CA

(21) Appl. No.: 10/273,418

(22) Filed: Oct. 16, 2002

(51) Int. Cl. G06F 17/60

(52) U.S. Cl. 705/37

(57) ABSTRACT

A network directory, a translation element, a registration element and an execution management element provide business process integration between trading partners. The network directory includes information relating to business processes and communication techniques for use with those trading partners. This directory includes a repository of information about objects and entities included in a platform for supply chain management. It includes descriptions of trading partners, administrative functions, business processes, principals and others. The directory can be used to perform such tasks as service discovery, principal authentication and administrative functions. Other elements of the invention such as the translation element, registration element and execution management element can be coupled to the network directory and provide for receiving messages in one or more particular formats, registering new trading partners, integrating new trading partners and providing oversight functions.

### BACKGROUND OF THE INVENTION

1. Field of the Invention

The invention relates to business process integration (for example, between supply chain trading partners).

2. Related Art Businesses, and other types of trading partners, sometimes find it cost effective to conduct business electronically, at least in part. Conducting business electronically can involve sending electronic messages between trading partners for communications directly involved in conducting business (for example, purchase orders, shipping notices, invoices, and the like). Conducting business electronically can also involve sending electronic messages between trading partners for other types of communications that might make a business relationship more cost effective (for example, projections of future need, commitments to provide products or services at future times, and the like). Some businesses use electronic systems and software (herein sometimes called “enterprise software”) which maintain and generate information relating to their trading partner relationships, as well as information relating to other aspects of their position in a supply chain including other trading partners (herein sometimes called “supply chain information”). Supply chain information might also include information on product specifications or design specifications, “end of life” notifications for products, and errata information regarding documentation or specifications for products.

A first problem in the known art is that there are multiple different software systems that maintain and generate supply chain information. However, if those trading partners use different software systems, an exchange of supply chain information between the partners might be difficult if it is necessary to translate between data formats used by those different software systems. Moreover, if those trading partners use different business processes (for example, the trading partners uses different business process steps or different data at similar business process steps), then exchanging information may be difficult if it is necessary to translate between business process steps and data in use by those different business processes.

A second problem in the known art is that even where such translation occurs, each trading partner manages the effort of such translation between data formats or business processes. Thus, in a system with multiple trading partners, each of which uses its own data formats or business processes, using that system involves each such trading partner being prepared to translate to each other data formats or business processes in use by any other trading partner who is a potential supply chain collaborator. A third problem in the known art is that even where such translation occurs, each trading partner discovers the data formats or business processes in use by other trading partners by manual techniques. Often such discovery involves communication between persons at those trading partners outside the automatic operation of enterprise software. Thus, in a system with multiple trading partners, each of which uses its own data formats and business processes, using that system involves each new trading partner communicating with each existing trading partner to inform them of the data formats and business processes in use by the new trading partner. The new trading partner may also communicate with existing trading partners to discover data formats and business processes in use by existing trading partners. It would be advantageous to provide a technique by which trading partners might automatically discover information relating to data formats and business processes for other trading partners.

A fourth problem in the known art is that even where such translation occurs, one or more of the trading partners might fail to recognize a business process transition, with the effect that one or more of the trading partners find themselves in a state in which the exchange of messages or information is no longer smooth. For one example, if a trading partner changes its procedures, counterparties might be caught unaware by the change (such as for example if a trading partner decreases the time during which it accepts commitments to purchase orders from ten days to five days). It would also be advantageous to provide a technique in which performance of those business processes by multiple trading partners is subject to oversight, with the effect that business processes in use between or among multiple trading partners continue to operate smoothly even in the face of miscommunication.

### SUMMARY OF THE INVENTION

A system, shared by multiple trading partners and coupling them in a shared collaborative trading partner system, provides an environment in which multiple trading partners can couple their business processes and can conduct business involving multiple products in one or more supply chains, with the effect of providing a many-to-many automated business-to-business environment. The system includes a network directory, a registration element and an execution management element that provide business process integration between trading partners. Other embodiments of this system include a translation element coupled to the network directory.

The network directory includes information relating to business processes and communication techniques for use with those trading partners, including in a preferred embodiment specific business process steps and those principals at each trading partner authorized to initiate those business process steps. This directory includes a repository of information about objects and entities included in an electronic platform for conducting business, preferably including, but not limited to supply chain management functions. The directory includes descriptions of trading partners, administrative functions, business processes, principals and others. The directory may be used when performing such tasks as information discovery, principal authentication and administrative functions.

The registration element is coupled to the network directory and to generic input and output devices such as client workstations. This has the effect of receiving information for registering new trading partners into the network directory and associating them for conducting electronic business processes with known trading partners already registered into the network directory. Trading partners seeking to do new business, when authorized to use the network directory, can use the network directory to discover those business processes for which they might become authorized to conduct with counterparties. Upon making those discoveries, trading partners seeking to do new business can follow standardized procedures with their prospective counterparties, with the effect that they become authorized to use the business process specifications in the network directory. These standardized procedures can themselves be described in the network directory as sequences of business process steps to be executed.

The execution management element can be coupled to the network directory and is coupled to messages relating to executing business processes. This provides an oversight function for on-going business processes, including execution of instructions relating to those business processes without direct trigger of such execution by the trading partners.

The translation element can be coupled to the network directory and can input trading partner communication links and output trading partner communication links. This has the effect of receiving messages relating to business processes and data formats used by the input trading partner and sending messages relating to business processes and data formats used by the output trading partner.

### BRIEF DESCRIPTION OF THE DRAWINGS

FIG. 1 shows a block diagram of a system including a network directory for business process integration between trading partners.

FIG. 2 shows a block diagram of a network directory.

FIG. 3 is a block diagram showing an example of a network directory.

FIG. 4 shows a process flow diagram of a method for adding information to a network directory for business process integration between trading partners.

FIG. 5 shows a process flow diagram of a method for modifying information in the network directory.

FIG. 6 shows a process flow diagram of a method that shows the use of a network directory by trading partners.

FIG. 7 shows a set of information flows between the network directory and other entities.

### DETAILED DESCRIPTION OF THE PREFERRED EMBODIMENT

In the following description, a preferred embodiment of the invention is described with regard to preferred process steps and data structures. Those skilled in the art would recognize after perusal of this application that embodiment of the invention can be implemented using one or more general-purpose processors, software or hardware, special-purpose processors or other circuits adapted to particular process steps and data structures described herein, and that implementation of particular process steps and data structures would not require undue experimentation or further invention.

### Lexicography

The following terms refer or relate to aspects of the invention as described below. The descriptions of general meanings of these terms are not intended to be limiting, only illustrative.

Business process—as used herein, a “business process” is a high level representation of a collaborative integration of a first trading partner with one or more other trading partners. The preferred business process used may have types and versions.

Company and Principal—as used herein the term “company” refers to a representation of a trading partner. A “principal” refers to a user that is a human being or a server under the control of a company in an electronic system for trading partners.

Directory—as used herein, the term “directory” refers to a repository of information about objects and entities included in a platform for business-to-business communication. The directory includes descriptions of trading partners, administrative functions, business processes, principals and others. The directory may be used to perform such tasks as service discovery, principal authentication, administrative functions, identification of business formats and processes and others functions.

Enterprise software—as used herein, the term “enterprise software” refers to software that helps maintain and generate information relating to one or more trading partner relationships, and can include information relating to other aspects of the supply chain management. Examples of enterprise software include products by Vitria, Tibco, IBM, Micsrosoft, RosettaNet and PDI.

Exception—as used herein, the term “exception” very broadly refers to any information in a directory, in a business process stored in that directory, or a business process using that directory, that has a property that requires it to be handled differently from a “normal” business process. For a first example, two companies that have the same name would be exceptions, with the effect that additional care must be taken to distinguish these companies from each other to avoid confusion. For a second example, an exception might include a selected scenario that triggers an alert to a supply chain management system or other enterprise software. For a third example, an exception might include a set of instructions to be performed in the event of a triggering event (and possibly a definition of the triggering event as well), with the effect that a hub would have the ability to respond to the triggering event with a trading partner's preferred remedy. Examples of such triggers might include deciding, on behalf of the trading partner, what to do if a selected supplier is unable to commit to a preset percentage of order, unable to commit to regarding a specified part number, or unable to commit within a preset time period. Examples of such preferred remedies might include deciding, on behalf of the trading partner, to resubmit the purchase order requesting only the committed quantity and to place a separate order for the difference with an alternative supplier.

Trading partner—as used herein, a “trading partner” describes a company that acts as a buyer, seller, supplier, collaborator, information provider or other participant in a business process.

### System Elements

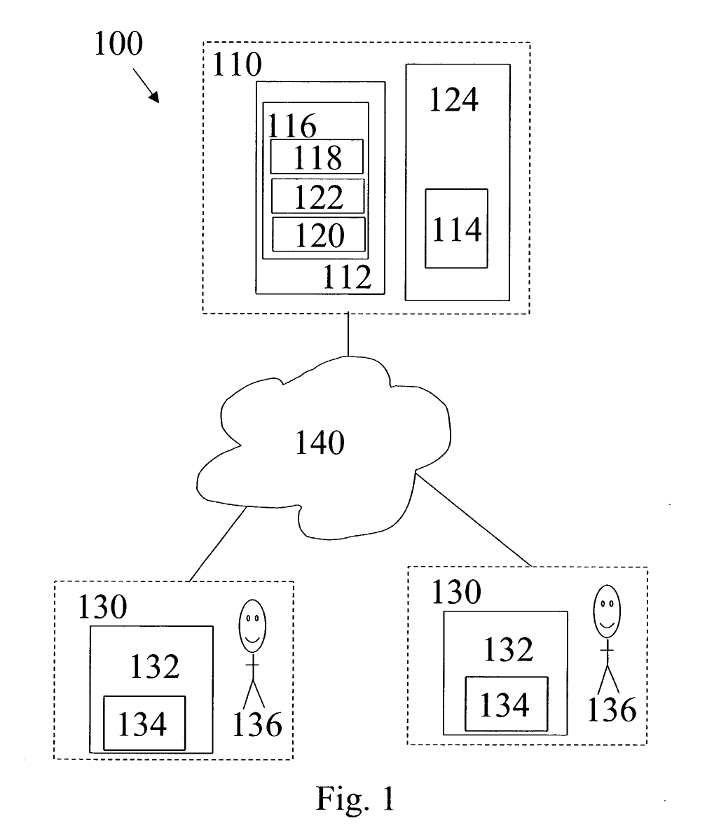

FIG. 1 shows a block diagram of a system including a network directory for business process integration between trading partners.

A system 100 includes one or more network hubs 110, a set of trading partners 130, and one or more communication links 140. Some embodiments may also include an authentication and authorization element 150. Although described herein as a network “hub” 110, there is no particular requirement in the context of the invention that the network hub 110 must be a centralized device of any kind, or be located in a centralized location of any kind. The network hub 110 might be distributed among a plurality of relatively remote locations, might include a plurality of devices operating in cooperation or relatively independently, and might include portions of multiple devices operating in cooperation, such as for example multiple software elements at different hardware devices cooperating to perform the functions described herein.

The network hub 110 includes at least one server 112, a network directory 114, a transaction coordinating element 116 and a security partition 124. In some embodiments, the network directory 114 may be disposed in a location either local or remote from the network hub 110. In some embodiments, the security partition 124 may be located within a network directory 114.

The server 112 may include one or more heavyweight servers, one or more lightweight servers, routers or some combination of these devices. Servers are characterized as heavyweight or lightweight according to the number of messages they can direct and process. Heavyweight servers can direct and process a relatively larger number of messages than lightweight servers. Similar to the description above with regard to the network hub 110, the servers may be in a single geographic location or may be situated in various different geographic locations. In various embodiments, these servers can cooperate among each other, be co-located or otherwise implemented in hardware or software.

The network directory 114 is a repository of information about each trading partner in the set of trading partners 130. In one embodiment, this information is stored in a tagged hierarchical directory such as a directed acyclic graph (or possibly a directed graph with some cycles) with the effect such that each node in the graph can perform the function of being a container for information. Information stored in such structures is interlinked with other information stored therein, as well as outside such structures. For example, information regarding a business process may be linked to other information about a company, such as for example contact information, descriptive documents, legal documents, and the like. In other embodiments the information may be stored in an object oriented or relational database, a flat file database, an XML data structure, or in other types of structures or repositories.

The information stored in the network directory includes at least some of the following:

The name of the trading partner and other identifiers including address, one or more contact people and their contact information, and a unique identifier, such as a D-U-N-S number (Dun (& Bradstreet) Unique Numerical Symbol) or Standard Industry Classification number, and other useful identification information. Such identifiers might be specific to selected business processes or selected types of contact, such as for example a address for general mail delivery, a telephone contact for customer service questions or reporting trading exceptions, or a web address for further information about the trading partner.

The types of business processes preferred by the trading partner. These can include trading partner agreements, connection details, supported services, message formats, interfaces, and process flows. As described above, such business process information can include detailed documentation for conducting business processes in a substantially automated manner, such as for example contact information for automated communication, data format information for such communication, documents regarding required or optional steps of specific business processes, documents regarding legal relationships between trading partners, documents regarding processes or requirements for approval as a new trading partner with the identified trading partner, and the like.

Descriptions of different structured or unstructured business processes (such as for example as described above);

Status information regarding registration of the trading partner (such as for example as described above), and possibly including such information as what stages in a registration process the trading partner has completed;

Status information about who is registered to do business with the trading partner (such as for example as described above), and possibly including such information as what other trading partners are permitted to conduct business with the trading partner, under what conditions, and for what specific business processes;

Configuration information for an input port and an output port used in communications between trading partners (such as for example as described above);

Other information relating to the trading partner and its business.

The security partition 124 controls access to the network directory 114 to any of the trading partners 130. In alternative embodiments, an authentication or authorization module may conduct some of these functions.

The security partition determines which trading partners 130 may be listed in the network directory 114. For example, the security partition performs the function of a gatekeeper in allowing or disallowing trading partners to be registered in the network directory 114. Only those trading partners registered in the network directory 114 can conduct business processes using the network directory 114.

The security partition determines which trading partners 130 may view information in the network directory 114. For example, the security partition performs the function of a gatekeeper in allowing or disallowing trading partners to review information in the network directory 114, such as for use in determining business processes available with other trading partners, and for use in contacting those other trading partners.

The security partition determines which trading partners may conduct business using information in the network directory 114. For example, the security partition performs the function of a gatekeeper in allowing or disallowing trading partners to read business process information from the network directory 114 so as to conduct those business processes with other trading partners, and in allowing the oversight manager to read about those business processes so as to conduct oversight of those business processes.

The security partition determines which trading partners 130 may use specific business processes identified in the network directory 114 as being available for use with counterparties. For example, the security partition performs the function of a gate-keeper in allowing or disallowing trading partners to consume (as described below) a specific business process provided (as described below) by another trading partner, as specified by information from the network directory 114.

In a preferred embodiment, trading partners 130 do not relate directly to each other at the hub 110; rather they relate to each other through a business process. For example, two corporations conducting business with each others each use particular business processes. Information regarding these processes is stored in the network directory 114.

The transaction coordinating element 116 includes a registration element 118 and an execution management element 122. Other embodiments can include a translation element 120. In some embodiments, the translation element 120 and execution management element 122 may form a single element. In some embodiments, the elements of the transaction coordinating element 116 may be located at different servers 112.

The registration element 118 enables a principal to add and store information to the network directory 114. This assumes, a priori, however, that the principal has been approved to add and store this information by the security partition 124.

The execution management element 122 includes a set of instructions for executing business transactions (for example, placing orders, establishing forecasts, processing commits and other transactions) that require input from a trading partner. The execution management element 122 also includes a set of instructions that provide oversight functions for on-going business processes that do not require immediate input from a trading partner (for example, processing payment of goods). In one embodiment, oversight functions include (1) specifying definitive binding business activities by trading partners with regard to each other, with the effect that purchases and sales are effected, actual shipping or manufacturing orders are given and received, and the like; (2) exceptions to business processes are noted, with the effect that differences in state information between pairs of trading partners are detected, and pre-selected remedial action is taken, such as for example informing each trading partner of the mismatch in business process viewpoint. These oversight functions allow the execution management element to automatically correct missteps in the communication between parties or errors in translation of a business format or process such as may occur when translating from a first format or process to another.

The translation element 120 includes a set of directions for using information in the network directory to carry out business transactions. For example, the translation element 120 includes instructions for the following:

Translating a communication generated using a first type of enterprise software into a communication that can be understood by a second type of enterprise software. For example, this has the effect that a first trading partner using RosettaNet can communicate with a second trading partner using EDI.

Translating a business format generated using a first type of enterprise software into a business format that can be understood by a second type of enterprise software. For example, this has the effect that a first trading partner using RosettaNet can communicate with a second trading partner using EDI.

Translating a business process such as used by a first trading partner into a business process used by a second trading partner. For example, this might include matching selected steps in paired business processes, with the effect that individual steps in two business processes shared by two trading partners, having the same function in the two business processes, are correlated so that each trading partner might conduct its own view of the individual step, while when individual steps in two business processes have different functions, each trading partner is made aware of the need for conducting the unmatched steps in the business process provided by the other trading partner.

Determining if a first trading partner is qualified to do business with a second trading partner. For example, this might include conducting a process by which a trading partner indicates which counterparties are qualified to conduct business with it.

Determining how to qualify a first trading party to do business with a second trading partner. For example, this might include conducting a process by which a trading partner allows new counterparties to qualify to conduct business with it.

In addition to the functions described above, the network directory 114 and transaction coordinating element 116 also perform services discovery, principal authentication, and administrative functions. These elements may also be used to facilitate data exchange between trading partners (for example involving product specifications, price lists, price updates, errata, and other information). Other software elements (either on the hub 110, on the trading partner 130) can also use the network directory for other purposes, such as marketing and sales. In other embodiments, the network 114 and transaction coordinating element 116 may be used in collaborative media creation. For example, different individuals or groups can collaborate on an audio-visual presentation (such as a TV commercial). Information stored in the network directory can be used to help smooth over any differences in preferred formats associated with these individuals or groups in the design collaboration process. Using such techniques, the final presentation can be produced more economically, or efficiently.

The trading partners 130 include a client device 132 under the control of a principal 136. The client device 132 may include a personal computer, a laptop, a handheld computer (such as a personal digital assistant), a set of multiple computing devices operating in concert or cooperation, a portion of a computing device used for a particular function (such as a software package used on a server), or some combination thereof, or any other device fitting within a computational paradigm. In some embodiments, the client device 132 may include enterprise software 136. The trading partners 130 may include one or more of the following: buyers, sellers, collaborators, entities in a supply chain, senders of information, recipients of information and other principals of a system 100. In one embodiment, the trading partners 130 include companies involved in electronics and computers.

The communication network 140 is disposed for communicating data between trading partners 130 and the network directory 114 and other elements of the system 100 such as trading partners 130, the registration element 118, the execution management element 122 and others. In a preferred embodiment, the communication network 140 includes a packet switched network such as the Internet, as well as (in conjunction with or instead of) an intranet, an enterprise network, an extranet, a virtual private network, a virtual switched network, or in one preferred embodiment in conjunction with a set of dedicated communication links. In alternative embodiments, the communication network 140 may include any other set of communication links that couple network hub 110 and the trading partners 130.

In other embodiments, a trading partner 130 can use the network directory 114 to communicate with third parties, third party hubs or both. (Similar to described above with regard to the network “hub,” there is no particular requirement in the context of the invention that a third party “hub” must be centralized in any way.)

In a first example of communication with third parties, a trading partner 130 who conducts business at a third party hub or collaborates with multiple trading partners can use information included in the network directory 114 to facilitate communication with these third parties. Such business may occur independently from business transactions that are conducted at the network hub 110 and may include continuous cycles of feedback through one or more design processes. In a second example of communication with third parties, a third party may include a payment process provider (such as a bank or credit card company). These third parties transactions as sometimes referred to as “out of band” processes. In a third example of communication with third parties, the third party might serve as a broker, a consultant, a facilitator of the transaction, and the like. In a fourth example of communication with third parties, the third party might make use of the network directory for publishing information or receiving published information, for transforming data from a first format to a second format (either at the request of trading partners or at the request of operators of the network directory), or for integrating business processes between trading partners (similarly, either at the request of trading partners or at the request of operators of the network directory), and the like.

Some embodiments also include an authentication and authorization module 150. The authentication and authorization module 150 ascertains (1) that the trading partner 130 is who they process to be and (2) that the trading partner 130 is authorized to perform the activities that they are trying to perform.

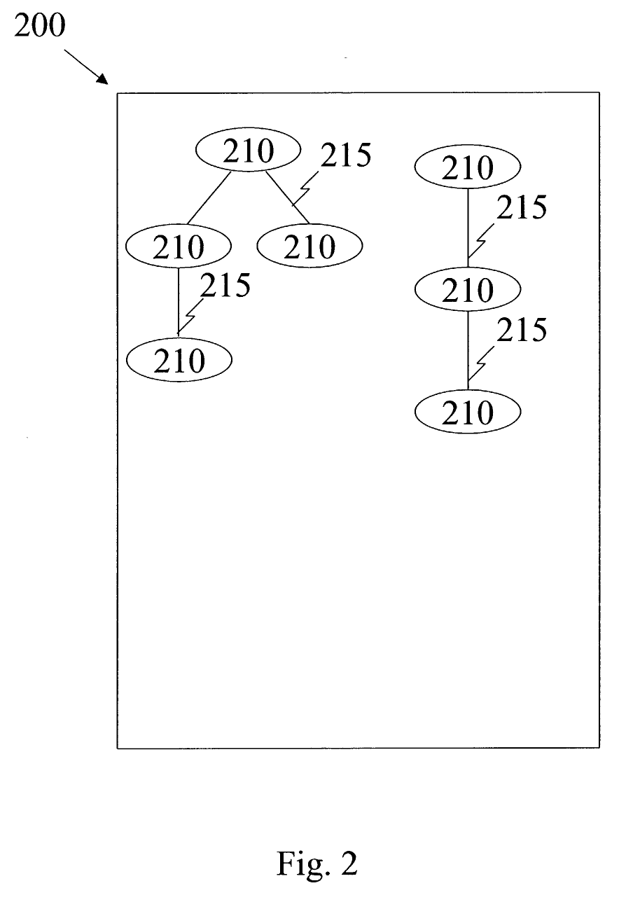

FIG. 2 shows a block diagram of one embodiment of a network directory.

A network directory 114 includes graph structure 200. The graph structure 200 includes a set of nodes 210 and a set of connections 215 between the nodes 210.

The graph structure 200 includes a tagged hierarchical graph such as a directed acyclic graph or other similar structure.

The nodes 210 include parent and child nodes. In some embodiments, the network directory 114 may also be a relational structure in which the child nodes are linked across hierarchies.

Regardless of the node type, each node is a container for different types of information. This information may include, similar to the information described above:

The name of the trading partner and other identifiers including address, one or more contact people and their contact information, and a unique identifier (such as D-U-N-S number, a Standard Industry Classification Number or similar identifier) and other useful identification information;

The type of business processes preferred by the trading partner. This can include trading partner agreements, connection details, supported services, message formats, interfaces, and process flows;

Structured or unstructured descriptions of different business processes;

Status information regarding registration of the trading partner;

Status information about who is registered to do business with the trading partner;

Configuration information for an input port and an output port used in communications between trading partners;

Other information relating to the trading partner and its' business.

The connections 215 link different nodes 210. By traversing the nodes 210 and connections 215, information about a particular company, process, configuration or other aspect of a trading partner or process may be found.

In other embodiments, the network directory 114 can be organized using a database scheme, having a set of tables and a set of relations between pairs of tables. In such embodiments, the network directory may include a relational database (such as available from Oracle or Informix, for example) or an object-oriented database, a flat file database or another type of database.

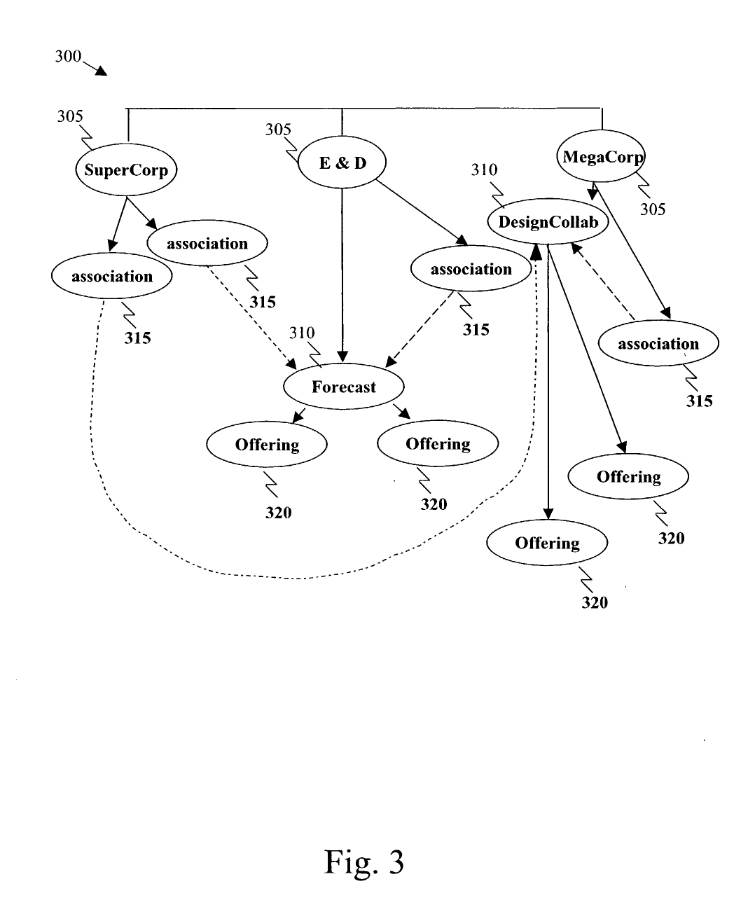

FIG. 3 is a block diagram showing an example of a network directory.

A system 300 includes a set of companies 305, a set of business processes 310, a set of associations 315 between companies and business processes 310 and a set of offerings 320.

The set of companies 305 includes trading partners 130 who, at a minimum, have registered and provided some information to the network directory 114. In this figure, the set of companies 305 includes SuperCorp, E & D, and MegaCorp. These companies are exemplary; there is no limit to the number or type of companies that may be included in the set of companies 305.

The set of business processes 310 may include those business processes used by trading partners 130 who are included in the set of companies 305. In this figure, E & D provides a business process named Forecast and MegaCorp provides a business process namedDesignCollab. These business processes are exemplary; there is no limit to the number or type of business processes that may be included in the set of business processes 310.

The set of associations 315 creates a relationship between the companies 305 and business processes 310. For example, FIG. 3 shows an association 315 between the company SuperCorp and the business process named Forecast. FIG. 3 also shows an association between E & D and Forecast and a third association between MegaCorp and DesignCollab.

The set of offerings 320 includes instances of products or services that are offered by the companies 305. For example, in FIG. 3, E & D and MegaKorp both show two offerings each.

The FIG. 3 may also be used to show consumption of business processes 310 by different companies. For example, in FIG. 3, SuperCorp is consuming both the Forecast and DesignCollab business processes. The term “consuming” a business process describes a relationship in which the business process is “provided” by a first trading partner and “consumed” by a second trading partner, with the effect that the business process is conducted between the first trading partner and the second trading partner.

### Methods of Use

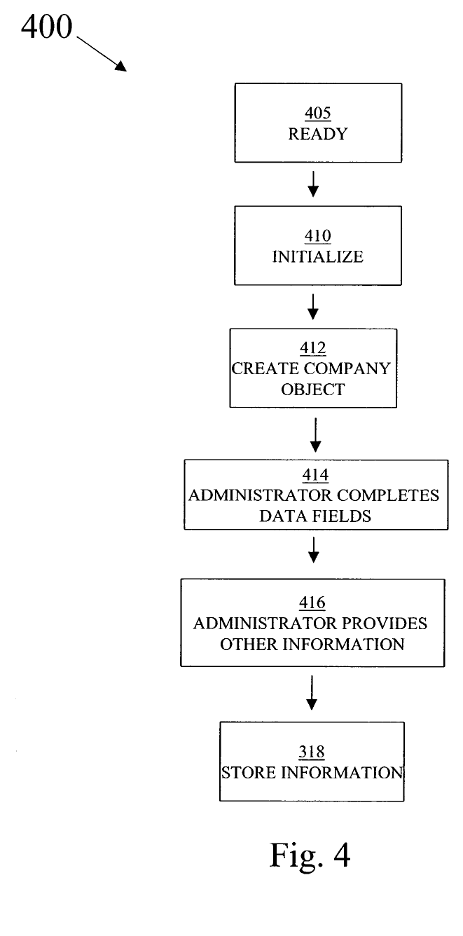

FIG. 4 shows a process flow diagram of a method for creating a network directory for business process integration between supply chain trading partners.

The method 400 is performed by the system 100. In other embodiments, the method 400 may be performed by other systems. Although the method 400 is described serially, the steps of the method 400 can be performed by separate elements in conjunction or parallel, whether asynchronously, in a pipelined manner, or otherwise. There is no particular requirement that the method 400 be performed in the same order in which this description lists the steps, except where so indicated.

At a flow point 405, the system 100 is ready to begin performing a method 400. At this flow point, a trading partner 130 has been identified that wishes to be included in the network directory 114.

In a step 410, a principal initializes the network directory 114. Initializing the network directory 114 involves preparing the directory for introduction of new data.

In a step 412, the principal creates a company object that is associated with the trading partner. The company object is a representation of the trading partner 130.

In a step 414, the principal completes various data fields associated with the company objects. These data fields include at least some of the following: the company name, the company domain component (e.g. “.com”, “.org”, “.biz” or other domain names), unique company identifiers (for example, the D-U-N-S number or other identifiers), and a business address. Other types of data may also be introduced. Information in these various data fields is referred to as the attributes of the company.

In a step 416, the principal includes such other information pertaining to the company as may be available. This information may include any of the following:

The type of business processes preferred by the trading partner. This includes agreements, connection details, supported services, message formats and process flows;

The type of enterprise software used by the trading partner;

Descriptions of services;

The type of business format preferred by the trading partner;

Status information regarding registration of the trading partner;

Information about who is registered to do business with the trading partner.

If this information is not presently available, it may be added at a future date. Entry of this information by an administrator or principal has the effect of publishing the information in the directory.

In a step 418, the principal stores the information in a memory associated with the network directory 114.

At this point in the method 400, the company exists within the network directory 114. In the event an exception arises (for example, a particular company name has been used before), an alternate way of entering the information into the memory associated with the network directory 114 could be developed.

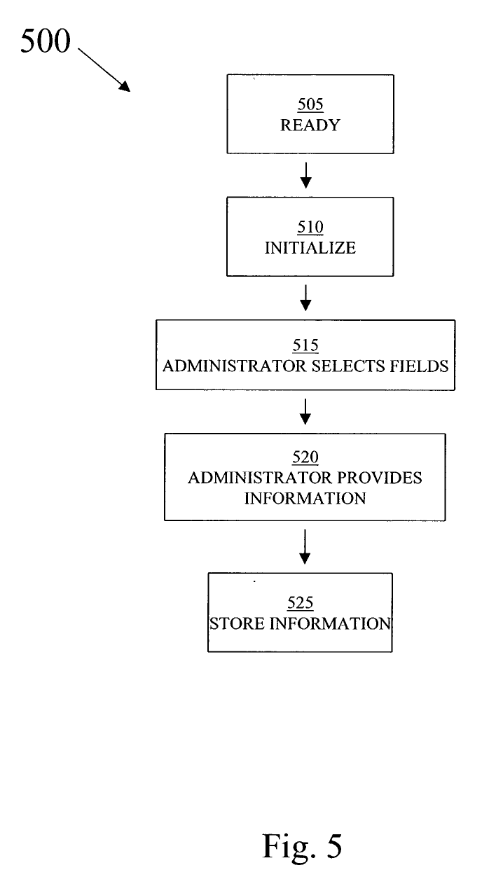

FIG. 5 shows a process flow diagram of a method for modifying information in the network directory.

The method 500 is performed by the system 100; in alternative embodiments, the method 500 can be performed by other systems. Although the method 500 is described serially, the steps of the method 500 can be performed by separate elements in conjunction or parallel, whether asynchronously, in a pipelined manner, or otherwise. There is no particular requirement that the method 500 be performed in the same order in which this description lists the steps, except where so indicated. Steps may be added, removed, or executed repeatedly within the method 500.

At a flow point 505, the system 100 is ready to begin performing a method 500. At this flow point, a method 500 has already been performed and information regarding a company is already present in the network directory 114. The method 500 is performed whenever it is desirable to (1) modify attributes associated with a company, (2) add a principal to the company, (3) modify attributes associated with a principal or (4) change preferred business formats, business processes or other procedures.

In a step 510, the principal initializes the network directory 114. Similar to the method 400, this involves preparing the network directory 114 for introduction of new data. Unlike the method 400, this further involves searching for and identifying a company that is already included in the network directory 114.

In a step 515, the principal selects fields associated with at least some of the following:

Attributes that are to be changed pertaining to the company;

Attributes that are to be deleted (for example, canceling or removing a registration)

New attributes pertaining to the company;

A new principal;

Attributes pertaining to a principal;

New attributes pertaining to a principal.

In a step 520, the principal provides information associated with the fields that were selected in step 515. For example, if the information concerns a principal who is an individual human being, the attributes may include a first name, last name, email address, work phone, title and other information. If the information concerns a principal that is a server, the attributes may include the X.509 certificate of the server, a description of the server or a root CA certificate.

In a step 525, the principal stores this information in a memory associated with the network directory 114.

At this point in the method 500, the new or modified information exists within the network directory 114. Various different exceptions may arise. These exceptions include any of the following circumstances:

The principal with the requested ID already exists in the network directory;

The email address with the principal already exists in the network directory;

There is incomplete information associated with the principal;

There is ill-formed attribute information;

The X509 certificate, other communication information, cannot be validated;

Required information is deleted or otherwise missing;

Other instances in which the information is inappropriate, incomplete or duplicative.

In the event one or more of these exceptions arises, an alternate way of publishing the information is developed.

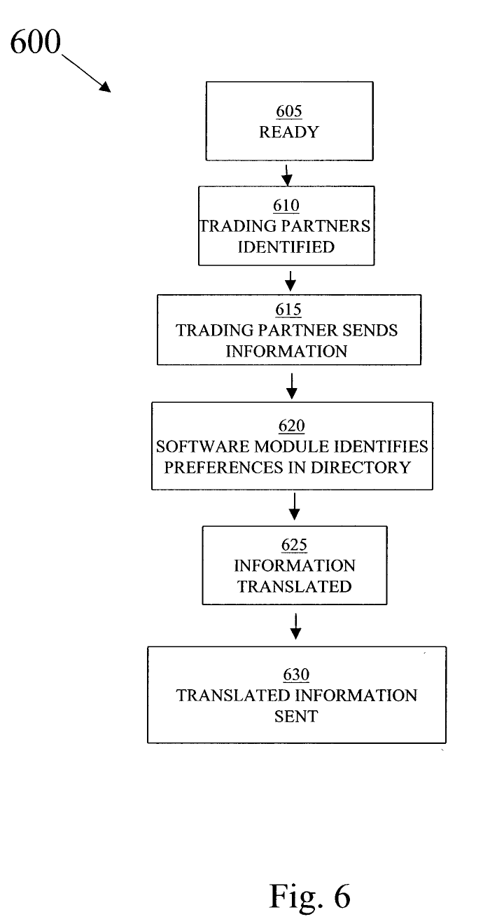

FIG. 6 shows a process flow diagram of a method that shows the use of a network directory by trading partners.

The method 600 is performed by the system 100; in alternative embodiments, the method 600 can be performed by other systems. Although the method 600 is described serially, the steps of the method 600 can be performed by separate elements in conjunction or parallel, whether asynchronously, in a pipelined manner, or otherwise. There is no particular requirement that the method 600 be performed in the same order in which this description lists the steps, except where so indicated. Steps may also be added, removed or executed repeatedly.

At a flow point 605, the system 100 is ready to begin performing a method 600. At this flow point, a method 400 has been performed and sufficient information about at least two trading partners who wish to conduct business together has been stored in the network directory 114.

In a step 610, two or more trading partners 130 wish to do business with each other using the network hub 110. If enterprise software 134 is associated with the trading partners, this enterprise software 134 may include similar or different software packages. Likewise, the business processes and business formats used by the trading partners 130 may be similar or different. Regardless of these similarities or differences, all the trading partners are registered and have information stored in the network directory 114. These trading partners 130 begin the process by logging on to the network hub 110.

In a step 615, one or more of the trading partners identifies a particular business activity that they wish to conduct. For example, they may wish to buy goods, sell goods, make a bid on goods, seek bid proposals, submit a purchase order, collaborate on a design, identify parts associated with a design or similar activities. This trading partner 130 identifies the type of transaction they wish to conduct and provides the names or identifiers of one or more other trading partners that they wish to conduct business with to the hub 110.

In a step 620, the transaction coordinating element 116 can identify particular information stored in the network directory 114 regarding the trading partners 130. This information includes at least some of the following:

The type of business processes published by the trading partner. This includes agreements, connection details, supported services, message formats and process flows;

Descriptions of different services;

The type of business format published by the trading partner;

Security preferences associated with the trading partner, particular regarding who may receive particular types of information;

Status information about who is registered to do business with the trading partner;

Information regarding registration of the trading partner.

In a step 625, the translation element 120 translates the information so that the information can be received by one or more other trading partners 130 in such a form that is preferred by them. For example, information that was initially sent in a using a product from RosettaNet is translated into information that can be received by a type of enterprise software used by the recipient. This translation could occur transparently to both the receiver and sender. Different business forms, practices, formats and transactions types can be translated to a form preferred by the recipient without altering their original meaning.

In a step 630, the translated information is sent to one or more of the recipients in a format that is preferred by the recipient.

The transaction between the two or more trading partners is conducted by repeating steps 6615 through step 6630 as often as necessary to complete the transaction. The execution management element 122 performs oversight functions and determines if the translations are appropriate or necessary and the sequence of messages between the trading partners 130 is correct.

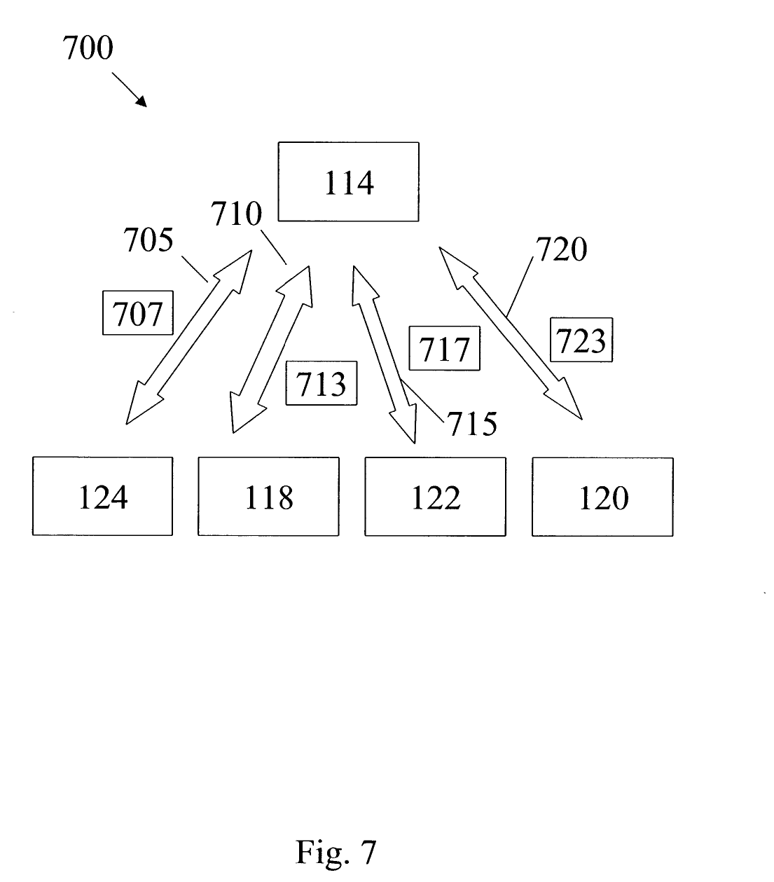

FIG. 7 shows a set of information flows between the network directory and other entities.

A system of information flows between the network directory 114 and other entities includes a set of data flows 700, the network directory 114, the security partition 124, the registration element 118, an execution management element 122 and one or more trading partners 130. Other embodiments may also include the translation element 120 and third parties.

The set of data flows 700 includes a data flow 705 between the network directory 114 and the security partition 124, a data flow 710 between the network directory 114 and the registration element 118, a data flow 715 between the network directory 114 and the execution management element 122. Other embodiments may also include a data flow 720 between the network directory 114 and the translation element 120.

The data flow 705 includes a set of messages 707 between the network directory 114 and the security partition 124. These messages include queries and responses as to who may write information to the network directory 114, who may read information stored in the network directory 114, who may translate information stored in the network directory 114 and other messages of a similar natures.

The data flow 710 includes a set of messages 713 between the network directory 114 and the registration element 118. Generally, the information in the messages 713 is provided by one or more trading partners 130 in the process of registration. The process of including this information in the network directory is also referred to as publication. The messages 713 include at least some of the following:

Attributes that are to be changed pertaining to the company;

New attributes pertaining to the company;

A new principal;

Attributes pertaining to a principal;

The type of business processes published by the trading partner. This includes agreements, connection details, supported services, message formats and process flows;

Descriptions of different services provided by the trading partner;

The type of business format published by the trading partner;

Security preferences associated with the trading partner, particular regarding who may receive particular types of information;

Status information about who is registered to do business with the trading partner.

The data flow 715 between the network directory 114 and the execution management element 122 includes a set of messages 717. The messages 717 include commands regarding the execution of different processes such as a command to limit or grant access to the network directory 114 to a trading partner 130, a command to translate a particular process or format stored in the network directory 114, a command to write to the network directory 114 and commands to create or modify nodes 210 or connections 215, and other commands.

The data flow 720 between the network directory 114 and the translation element 120 includes a set of messages 723. The set of messages 723 includes translation requests from trading partners and third parties and responses to those requests. The translation requests from trading partners 130 or third parties generally involve requests to translate a first business process into a second business process or to translate a first business process into a different version of that business process. Responses to those requests include the translated information or a refusal to translate the information.

### Alternative Embodiments

The invention has additional applicability to business processes besides supply chain management, including without limitation, the general problem of data exchange between trading partners or other businesses, such as for design collaboration, product specifications, product design errata, and “end of life” notices for product support.

Although preferred embodiments are disclosed herein, many variations are possible which remain within the concept, scope, and spirit of the invention. These variations would become clear to those skilled in the art after perusal of this application.

1. An apparatus, including
a network directory having a set of information pertaining to preferred business formats and preferred business processes of a set of trading partners; and
a security parameter, including a set of limitations governing what parties may be included in said network directory, who may access said network directory and who may conduct business using said network directory; and
an execution element coupled to said network directory.

2. An apparatus as in claim 1, also including a translation element coupled to said directory, wherein said translation element transparently translates data from a first preferred business format or process to a second preferred business format or process

3. An apparatus as in claim 1, wherein said network directory includes a set of security preferences that are set by individual trading partners included in said set of trading partners.

4. An apparatus as in claim 1, wherein said set of information also includes at least some of the following: name of said trading partners and other identifiers including address, various contact people and their contact information and unique identifiers.

5. An apparatus as in claim 1, wherein said set of information includes status information regarding registration of individual trading partners in said set of trading partners and status information about who is registered to do business with said individual trading partners.

6. An apparatus as in claim 1, wherein said hub provides supply chain management services for companies involved in at least one of the following: computers, computer components, electronics, semiconductors and information technology.

7. An apparatus as in claim 1, wherein said translation element inputs and output information relating to trading partner communication links.

8. An apparatus as in claim 1, also including a registration element coupled to said network directory wherein said registration element receives information for registering new trading partners.

9. An apparatus as in claim 8, wherein said registration element also receives information for altering a set of registration information.

10. A method, including
receiving registration information pertaining to a trading partner who wishes to conduct business at a hub;
receiving a set of preference information relating to business formats and business processes preferred by said trading partner;
storing a first portion of said registration information in a public portion of a network directory and storing a second portion of said registration information in a private portion of a network directory; and
storing said set of preference information in said private portion of said network directory.

11. A method as in claim 10, wherein said registration information includes as least some of the following: a name of said trading partner and other identifiers including address, various contact people and their personal information, a DUNS number and a Standard Industry Classification Number.

12. A method as in claim 10, wherein said network directory is coupled to a translation element that provides translation services, including transparently translating a business translation from a format preferred by a first trading partner into a format preferred by a second trading partner.

13. A method as in claim 10, wherein said network directory is coupled to a translation element that provides translation services, including transparently translating a business translation from a process preferred by a first trading partner into a format and process preferred by a second trading partner.

14. A method as in claim 10, also including steps of
managing exceptions relating to said registration information.

15. A method as in claim 10, also including steps of
managing exceptions relating to said set of preference information.

16. A method, including
receiving information from a first trading partner at a hub, wherein said information was generated using a first format and a first business process, and is directed to a second trading partner;
consulting a network directory to determine a set of preferences associated with said second trading partner;
transparently translating said information from said first format and first business process to a second format and second business process in response to said set of preferences; and
sending said information to said second trading partner.

17. A method as in claim 16, wherein said hub provides supply chain management services for companies involved in computers, computer components, electronics, semiconductors and information technology.

18. A method as in claim 16, including steps of inputting information relating to preferred trading partner communication link; and outputting said information in said preferred trading partner communication link.

19. A method as in claim 16, including steps of inputting information relating to preferred trading partner communication link; and outputting said information in a different preferred trading partner communication link.

20. A method as in claim 16, including steps of
managing exceptions relating to said step of transparently translating.

21. Apparatus including a memory storing a computer program, said computer program including
a network directory having a set of secure and separate information pertaining to preferred business formats and preferred business processes of a set of trading partners;
a translation element coupled to said directory, wherein said translation element transparently translates data from a first preferred business format or process to a second preferred business format or process; and
an execution element coupled to said directory, wherein said execution element performs oversight functions related to said translation element.

22. An apparatus as in claim 21, wherein said network directory includes a set of security preferences that are set by at least one of the following: an individual trading partners, a principal or a trusted party.

23. An apparatus as in claim 21, wherein said set of secure and separate information also includes at least some of the following: a name of said trading partners and other identifiers including address, a contact person, personal information for a contact person, a DUNS number, a Standard Industry Classification Number.

24. An apparatus as in claim 21, wherein said set of secure and a separate information includes status information regarding registration of individual trading partners in said set of trading partners and status information about who is registered to do business with said individual trading partners.

25. An apparatus as in claim 21, wherein a hub coupled to said network directory provides supply chain management services for companies involved in computers, computer components, electronics, semiconductors and information technology.

26. An apparatus as in claim 21, wherein said translation element inputs and output information relating to trading partner communication links.

27. An apparatus as in claim 21, also including a registration element coupled to said network directory wherein said registration element receives information for registering new trading partners.

28. An apparatus as in claim 27, wherein said registration element also receives information for altering a set of registration information.

29. A memory storing information including instructions, the instructions executable by a processor, the instructions including
receiving registration information pertaining to a trading partner who wishes to conduct business at a hub;
receiving a set of preference information relating to business formats and business processes preferred by said trading partner;
storing a first portion of said registration information in a public portion of a network directory and storing a second portion of said registration information in a private portion of a network directory; and
storing said set of preference information in said private portion of said network directory.

30. A memory as in claim 29, wherein said registration information includes as least some of the following: a name of said trading partner and other identifiers including address, various contact people and their personal information, a DUNS number and a Standard Industry Classification Number.

31. A memory as in claim 29, wherein said network directory is coupled to a translation element that provides translation services, including transparently translating a business translation from a format preferred by a first trading partner into a format preferred by a second trading partner.

32. A memory as in claim 29, wherein said network directory is coupled to a translation element that provides translation services, including transparently translating a business translation from a process preferred by a first trading partner into a process preferred by a second trading partner.

33. A memory as in claim 29, also including steps of
managing exceptions relating to said registration information.

34. A memory as in claim 29, also including steps of
managing exceptions relating to said set of preference information.

35. A memory storing information including instructions, the instructions executable by a processor, the instructions including
receiving information from a first trading partner at a hub, wherein said information was generated using a first format and a first business process, and is directed to a second trading partner;
consulting a network directory to determine a set of preferences associated with said second trading partner;
transparently translating said information from said first format and first business process to a second format and second business process in response to said set of preferences; and
sending said information to said second trading partner.

36. A memory as in claim 35, wherein said hub provides supply chain management services for companies involved in computers, computer components, electronics, semiconductors and information technology.

37. A memory as in claim 35, including steps of
inputting information relating to preferred trading partner communication link; and
outputting said information in said preferred trading partner communication link.

38. A memory as in claim 35, including steps of
managing exceptions relating to said step of transparently translating.
